(19) United States
(12) Patent Application Publication
(10) Pub. No.: US 2007/0209488 A1
(43) Pub. Date: Sep. 13, 2007

(54) ERGONOMIC TOOL HANDLE

(76) Inventor: Alexis J. Nogueras, Miami, FL (US)

Correspondence Address: ROBERT M. SCHWARTZ, P.A., P.O. BOX 221470, HOLLYWOOD, FL, 33022, US

(21) Appl. No.: 11/682,954

(22) Filed: Mar. 7, 2007

Related U.S. Application Data
(60) Provisional application No. 60/779,988, filed on Mar. 7, 2006.

(51) Int. Cl. B25G 1/01

(52) U.S. Cl. 81/489

(57) ABSTRACT

The present invention is a tool handle and method of use that has an ergonomic configuration including a proximal grip, medial portion and distal grip having three angular inflections in the same vertical plane allowing greater ease of use.

### INDEX TO RELATED APPLICATION

This application claims the benefit of U.S. Provisional Patent Application Ser. No. 60/779,988 filed Mar. 7, 2006 the disclosure of which is incorporated herein by reference in its entirety.

### BACKGROUND OF THE INVENTION

One of the basic goals of ergonomic tool design is to determine a handle shape which can reduce discomfort and improve performance, through proper fit. Therefore, comprehensible criteria for handle specifications are sought, to translate the subjective construct of “proper fit” into relatively more clear-cut engineering terms. In sum, this tool handle innovation represents a simple rule for manufacture, in order to create an “ergonomic” tool handle. The premise of this invention is that, tool handles, with a certain angular configuration, will substantially reduce problems of user discomfort, and increase tool use effectiveness, at a worthwhile cost of manufacture.

The handle, in this invention, is specially designed to acknowledge the natural angles between the gripping portion of the hand, the axis of the forearm, and their alignment with the torso, during use. This tool handle configuration tries to conform to a certain anatomical posture, emphasizing a relatively straight, balanced, and relaxed alignment of the wrist, arm and torso. This certain posture describes a pointing-type hand grip, a straight wrist, and a partially bent elbow more or less close to a generally erect torso. The maintenance of this posture improves the likelihood of tool control and comfort during work performance. The handle, in this invention, allows the user to execute work activities, from this certain posture, more often than conventional prior art handles. The resultant benefits from such an advantage are substantial.

To further accommodate the depth aspects of the hand, another feature of grip design should be recognized, namely, orientation of conforming grip planes. The use of conforming planar surfaces, on a tool handle grip, relates to the problem of providing a larger area of interface for transferring forces between the hand and tool. Any accompanying facets, or edges, of such planes can also provide resistance to twisting and slipping forces, as well as additional sensory feedback for control decisions. But, they also increase friction effects and can reduce specific areas of needed interface.

The selection of varying cross-section tool handle shapes (whether circular, ovate, square, or polygonal) relates to such dynamics. Each type of cross-section offers different performance characteristics. A tool handle with a circular cross-section allows a uniform rotation of the gripping hand to adjust to a comfortable gripping posture, for varying tool orientations. The ovate cross-section is a close approximation of the shape of the closed hand. The polygonal cross-section offers both flat planes and facets. Furthermore, certain applications employ supplemental cushion grips of varying textures and shapes, to overcome the usual interfacing problems, as well as excessive pressure, vibration, or slippage demands.

There have been previous attempts to vary handle angles and shapes of grips. All handle and grip designs are a compromise of such desirable and detrimental features, balanced against the particular application. Such considerations often lead to complex configurations that are difficult to manufacture.

There is a need for an ergonomic handle for tools, such as rakes, shovels and hoes that are easy to use, simple and economical to manufacture, and address the needs not properly addressed by prior attempts.

### BRIEF SUMMARY OF THE INVENTION

In one embodiment the present invention is a tool handle for attachment to a tool comprising:
(a) a proximal grip;
(b) a medial portion, connected to said proximal handle portion at an angular vertex;
(c) a distal grip connected to said medial handle portion at an angular vertex;
(d) a shaft connected at one end of said distal handle portion at an angular vertex and another end to a tool;
wherein each of said angular vertices are along a contiguous handle with three angular inflections.

The tool handle has inflections that are each above the axis of the horizontal plane containing a longitudinal axis. In a preferred embodiment, the tool handle angular inflections lie in a common vertical plane.

The tool handle has a proximal grip that forms an angular vertex with the medial portion such that the angle x formed on the underside of said handle is obtuse.

The tool handle also includes a second angular grip that forms an angular vertex with the distal end of said medial portion such that the angle y formed on the underside of said handle is obtuse.

In a preferred embodiment, angles x and y are congruent. The angles x and y are obtuse and have a measure between 110°-170°.

The tool handle further includes a main handle cavity that is present along the entire inner length of the handle. The inner cavity allows the manufactured handle to be light, strong, and formed of a single contiguous piece.

The medial handle portion also includes a shoulder elevated from the upper surface of said medial handle portion. The shoulder has an interior medial handle cavity. Additionally, the shoulder may include indicia incorporated into the upper surface of the shoulder.

Preferably, the shaft of the tool handle lies in the same horizontal plane as a tool dependent on the handle.

As discussed above, the tool handle is preferably formed of a single contiguous piece and includes a tool portion dependent thereon.

In one embodiment, the tool portion is formed as a single contiguous unit with the handle.

Alternatively, may include a connect/disconnect for the attachment and detachment of a tool.

It is an object of the present invention to provide a tool handle with an ergonomic configuration that allows a user greater ease in using a tool.

It is another object of the present invention to provide a tool handle which may be used with many different types of tools.

It is another object of the present invention to provide a tool handle configured with three angular portions.

It is another object of the present invention to provide a tool dependent on a tool handle wherein the tool and handle are formed of a single contiguous piece.

### BRIEF DESCRIPTION OF THE DRAWINGS

FIG. 1 is a perspective view of the handle of the present invention.

FIG. 2 is a side view of the tool handle of the present invention.

FIG. 3 is a cross section of the tool handle through lines A-A shown in FIG. 2 and shows the central cavity included within the handle.

FIG. 4 is a cross-section of the tool handle through lines B-B shown in FIG. 2 and shows the central cavity included within the handle and the upper cavity contained within the shoulder or protruding from the upper surface of the medial handle portion.

FIG. 5 is a top view showing the tool handle of the present invention.

FIG. 6 is a bottom view showing the tool handle of the present invention.

FIG. 7 is a front view of the tool handle the present invention.

FIG. 8 is a rearview of the tool handle of the present invention.

FIG. 9 is cut away view of an embodiment of the present invention whereby the tool may be attached and detached from the tool handle by a connect/disconnect arrangement.

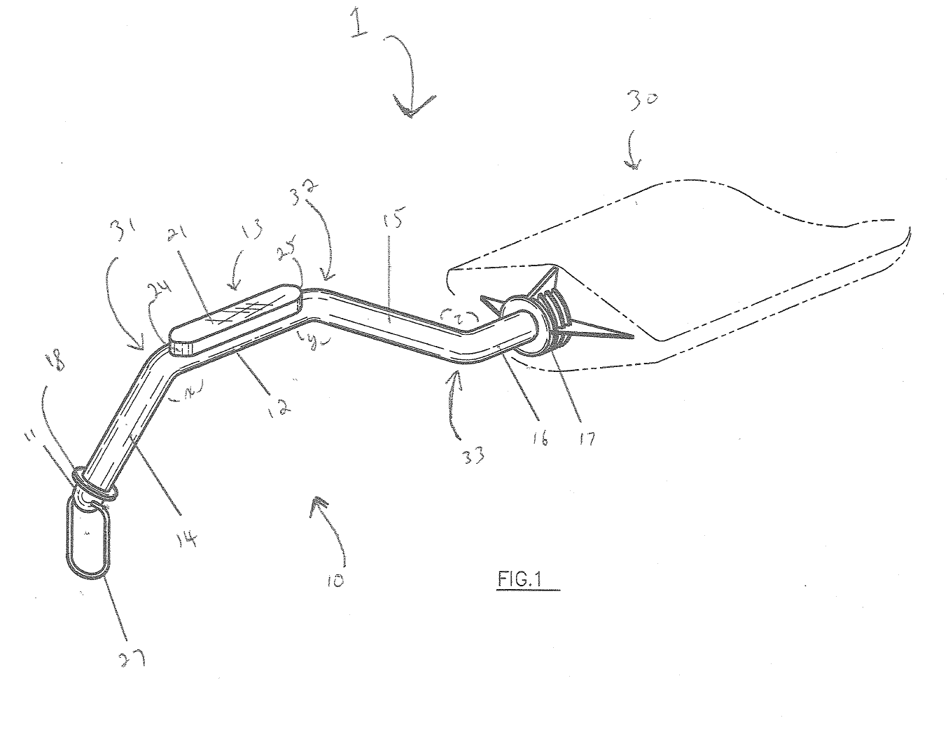

### DETAILED DESCRIPTION OF THE PREFERRED EMBODIMENTS

The present invention is a tool 1 having a handle 10 joined to a tool head 30 shown in phantom. Handle 10 has a proximal grip 14, a medial portion 12, a distal grip 15, and a shaft 16. Grip 14 has a proximal end 11 and a proximal flange 18 placed near proximal end 11. Shaft 16 has a flanged distal end 17 which connects to tool head 30. Tool head 30 is attached to shaft 16 at distal end 17 and may be any hand tool including but not limited to a shovel, hoe, rake, and the like.

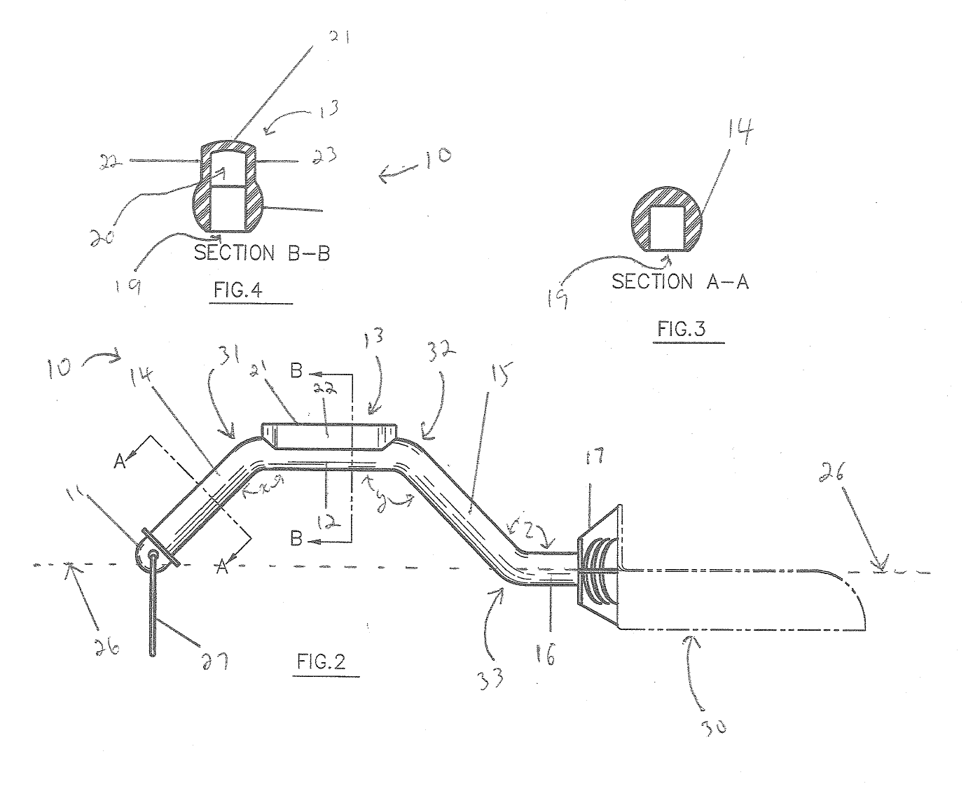

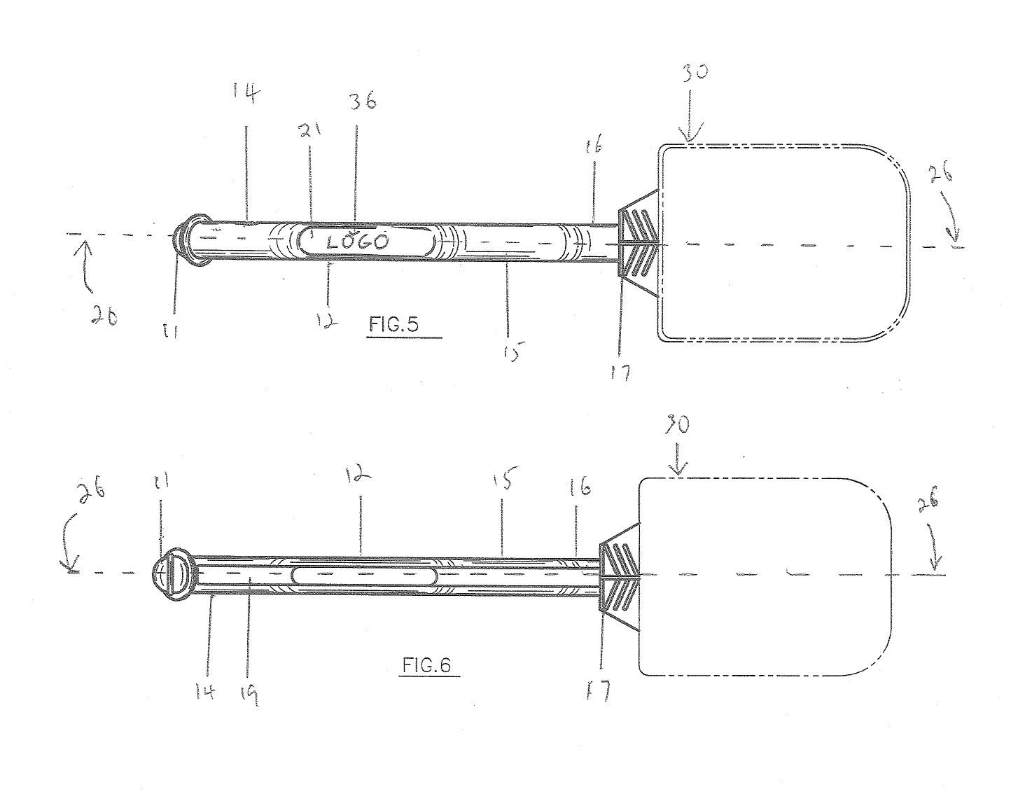

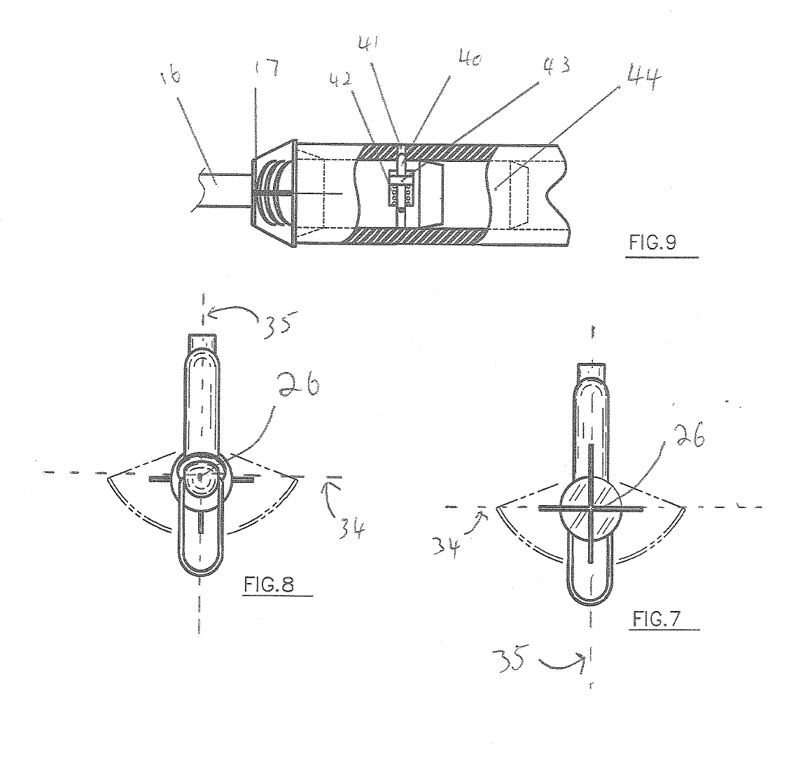

As shown in FIG. 2, angle ‘x’ is formed at the angular vertex where grip 14 and medial portion 12 intersect. Angle ‘y’ is formed at the angular vertex where medial portion 12 and distal grip 15 intersect. Angle ‘z’ is formed at the angular vertex where distal grip 15 and shaft 16 intersect. Preferably, each of angles x, y, and z are congruent. Also preferred, each angle is obtuse measuring 110°-170°. In a preferred embodiment, angles x, y, and z are 120°-150°. Tool 1 has a longitudinal axis 26 as shown in FIGS. 2, 5, and 6. Shaft 16 is along longitudinal axis 26 of tool 1.

Handle 10 includes a central channel 19 that forms the interior of handle 10. Channel 19 runs the entire length of handle 10 from proximal end 11 to distal end 17.

Medial portion 12 has an upper protrusion 13 having an upper surface 21, a first longitudinal side 22, a second longitudinal side 23, meeting to form a first curved end 24 and a second curved end 25. A product name/logo 36 may be placed or embossed on upper surface 21. Said name 36 may be placed with an adhesive label or may be formed directly into the surface of upper surface 21 (not shown). An upper channel 20 is formed within upper protrusion 13.

Handle 10 has angular inflections formed at angles x, y, and z. A first angular inflection 31, forms angle x and is at the vertex where grip 14 and medial portion 12 intersect. A second angular inflection 32, forms angle y and is at the vertex where medial portion 12 and distal grip 15 intersect. A third angular inflection 33, forms angle z and is at the vertex where medial distal grip 15 and shaft 16 intersect. A horizontal plane 34 and vertical plane 35 intersect at axis 26 and are perpendicular to one another. Angular inflections 31, 32, and 33 lie in a common vertical plane 35 and are above axis 26 and above horizontal plane 34.

Handle 10 includes a hanger 27 for hanging tool 1 for storage when not in use.

The present invention may be utilized in several ways. In one contemplated use, a user will operate tool 1 of the present invention by grasping first grip 14 and second grip 15. The user will then lower the second grip 15 in order to operate the tool head 30 in a desired manner. The user will apply downward force on the first grip 14 and take advantage of the leverage of the ergonomic configuration of handle 10 to more easily operate the tool head 30 dependent thereon.

A user may also choose to use tool 1 by grasping the first grip 14 and shaft 16. This mode of use may be preferred when the user desires to exercise increased control in the use of tool 1.

Another embodiment, as seen in FIG. 9 provides for a quick connect/disconnect for allowing changeable tool heads to be used with a handle of the invention. The embodiment depicted is for illustration and it is contemplated that the intention of removable tool heads be accomplished by any acceptable means. A spring-loaded mechanism includes a spring loaded plunger 40, a receiving socket 41, spring 42 and a handle 43 that secures tool head connector 44 into a locked position. Spring 42 urges plunger 40 in the direction of socket 41. To disconnect, handle 43 is moved towards the side wall opposite socket 41. Handle 41 is connected to plunger 40 and movement disengages plunger 40 from socket 41. Connector 44 is then moved in a direction away from shaft 16 and connector 44 and dependent tool head 30 (not shown) is disconnected from the arrangement.

Handle 10 may be made of any appropriate material including plastics, metals, synthetics, composites and the like. In a preferred embodiment, handle 10 is made of a composite comprising approximately 10-50% glass and approximately 50-90% nylon.

### EXAMPLE

One embodiment of the present invention tool 1 was tested for efficacy.

A representative sample of potential users, stratified by age, gender, and gardening experience was recruited to create a balanced test sample. The three age categories were Young (from 18 to 30 years old), Mid-Aged (from 31 to 50 years old), and Elder (51 years old and up). The three experience levels were

Novice (has never or hardly ever used a garden tool), Semi-Experienced (uses a garden tool at least once a week) and Experienced (uses a garden tool at least three times a week). A table with all our test subjects and their respective categories are displayed in table 1.

TABLE 1
Test Subject Table
Test Subject list

| # | Gender | Age Group | Experience Level |
|---|---|---|---|
| 1 | Female | Mid-Aged | Experienced |
| 2 | Female | Young | Novice |
| 3 | Male | Elder | Semi-Experienced |
| 4 | Male | Elder | Semi-Experienced |
| 5 | Male | Young | Experienced |
| 6 | Female | Young | Novice |
| 7 | Female | Mid-Aged | Semi-Experienced |
| 8 | Male | Mid-Aged | Experienced |
| 9 | Female | Elder | Experienced |
| 10 | Male | Mid-Aged | Novice |
| 11 | Female | Elder | Semi-Experienced |
| 12 | Male | Young | Novice |
| 13 | Female | Young | Novice |

### 3. Tasks

### 3.1. Task Design

Two tasks were assigned to the test participants, including one performed at ground level and the second performed at a raised level. This expands the generalizability of the test results. The raised task requires the user to scoop out a heavy material from a bag and place it in a container. The dimensions used for the gardening container in this task were 30″ L×10″ W×8″ D, and the heavy material utilized was sand obtained from a playground. To ensure sufficient opportunity for fatigue, participants were instructed to fill the container, refill the bag, and then refill the container once more. The second task was to dig holes at ground level. This was chosen because it is a common task and can evaluate postural differences when bending is likely. Users were instructed to dig mid-sized holes (about 9″ in diameter and 11″ in depth) in soil and refill them upon completion. Four holes were assigned for this task to evaluate the effects of fatigue.

### 3.2. Assignment of Tasks

A list of assigned tasks is displayed in Table 2. The heading “Shovel” represents the standard digging tool and the heading “Digger” represents tool 1 having tool head 30 as a shovel whereby handle 10 is configured according to the present invention. The “Dig” title stands for the digging in soil task and the “Fill” title stands for the task of scooping sand from a bag and placing it into a container. The check marks signify that the user performed a specific task. Blank spaces indicate that the user did not perform the task. There were two reasons for omitted tasks. Some participants were unable to attend the second session. Some older participants were unable to perform the digging tasks because of the bent postures required. Because of the balanced order in which the tasks were assigned, all tasks were completed by the same number of participants. This is illustrated in Table 3.

TABLE 2
Task Assignment List
Participant Task Assignment List

| | |
|---|---|
| Shovel | Digger |

| Participant # | Dig | Fill | Dig | Fill |
|---|---|---|---|---|
| 1 | ✓ | | ✓ | |
| 2 | ✓ | ✓ | ✓ | ✓ |
| 3 | ✓ | | ✓ | ✓ |
| 4 | ✓ | ✓ | ✓ | ✓ |
| 5 | ✓ | ✓ | ✓ | |
| 6 | | ✓ | | ✓ |
| 7 | ✓ | ✓ | ✓ | ✓ |
| 8 | ✓ | ✓ | ✓ | ✓ |
| 9 | | ✓ | | ✓ |
| 10 | ✓ | | ✓ | |
| 11 | ✓ | | ✓ | |
| 12 | | ✓ | | ✓ |
| 13 | ✓ | ✓ | ✓ | ✓ |
| Total Observations | 10 | 9 | 10 | 9 |

TABLE 3
Number of Participants per Category in Each Test

| | |
|---|---|
| Shovel | Digger |

| Category | Dig | Fill | Dig | Fill |
|---|---|---|---|---|
| Novice | 3 | 4 | 3 | 4 |
| Semi-Experienced | 4 | 2 | 4 | 3 |
| Experienced | 3 | 3 | 3 | 3 |
| Female | 5 | 5 | 5 | 5 |
| Male | 5 | 4 | 5 | 5 |
| Young | 3 | 5 | 3 | 5 |
| Mid-Aged | 4 | 2 | 4 | 2 |
| Elder | 3 | 2 | 3 | 3 |

### 4. Testing Environment

Participants performed the tasks under regular and natural gardening conditions to simulate the typical gardening environment. The effects of alternate conditions were not within the scope of the study. Participants worked at their own speed and were not pressured. The target gardening environment typically is not done under significant time constraints.

### 5. Key Performance Indicators (KPI's)

### 5.1. Evaluation Tools

In order to provide an ergonomic assessment of the Digger and compare it to a standard tool, a variety of validated ergonomic tools were used to measure the stress, strain, health risks, fatigue, and discomfort experienced by users of the tools.

The Rapid Upper Limb Assessment (RULA) and the Standard Posture Classification System (SPCS) were used to evaluate the postures required to use the tools, predict levels of fatigue, and to quantify an overall level of ergonomic risk for each task/tool combination. RULA is a postural targeting method for estimating the risks of work-related upper limb disorders that is both quick and systematic¹. SPCS evaluation provides a longitudinal quantification of assumed postures to assess repetitive trauma risk and estimate fatigue. The wrist and shoulder postures were targeted in the study because these joints are the two most heavily required by the tasks. McAtamney, L. and Corlett , E. N. RULA: A survey method for the investigation of work-related upper limb disorders. Applied Ergonomics, Vol. 24, No. 3, 91-99, 1993.

### 5.2. Objective Assessment Methodology: SPCS and RULA Evaluation

The output of the RULA is an overall rating of risk for each task/tool combination ranging from 1 to 7. A rating of 1 or 2 indicated that the activity is acceptable and safe, while a 7 rating indicates that the activity has a high risk of upper limb disorder requiring immediate investigation and modification (McAtamney and Corlett, 1993). The method by which the ratings were computed is displayed in a sample RULA chart in appendix 9.

The SPCS evaluation quantifies the percentage of time that each joint is in a neutral, mild or severe posture. This determines the risk of repetitive strain on any targeted joints and allows levels of local muscular fatigue to be estimated. A weighted average was used to create an overall exertion score for the SPCS results.

During the test, some participants used both hands when performing tasks with the Digger, so the limiting score (the one with the most extreme posture) was used for further analysis.

### 5.3. Subjective Assessment Methodology: Fatigue and Discomfort Evaluation

Subjective ratings were used to elicit whole body ratings of perceived fatigue and discomfort. The 5-point unipolar Likert scale is shown in Table 4. Participants rated each task/tool combination. Participants were also asked to report specific details about any of the discomforts that they experienced while performing the task.

TABLE 4
Discomfort and Fatigue Rating Scale

| Rating | Discomfot or Fatigue |
|---|---|
| 1 | None |
| 2 | Mild or slight |
| 3 | Moderate |
| 4 | Fairly significant |
| 5 | Substantial |

### 6. Data Analysis Methodology

The focus of the data analysis was to compare the posture, fatigue, and discomfort of the Digger with the standard tool. Stratified analysis was used for subevaluations of each participant subcategory. Paired T-Tests were used to measure the statistical significance of the differences.

### 7. Test Results and Data Analysis

### 8.1. Filling Task General Results

The testing results for the filling activity are displayed in table 6, which portrays the overall sample averages of each performance indicator and the average scores within each user category. The individual participant data for this task is displayed in appendix 1. The data indicates that for the filling task the Digger performed poorer than the regular shovel in all KPI categories with the exception of the SPCS wrist rating. The Digger was capable of maintaining a better wrist posture in the majority of instances of the filling activity, and had an 8.5% overall average improvement in wrist posture. However, the RULA assessment revealed a 24% higher risk of injury, and the overall SPCS shoulder rating, fatigue rating, and discomfort rating indicated 44%, 44%, and 23% increases in these categories respectively.

TABLE 4
Filling Task KPI Averages by Category

| | Shovel | | | | | Digger | | | | |
|---|---|---|---|---|---|---|---|---|---|---|
| Category | RULA | Fatigue | Discomfort | SPCS-W | SPCS-S | RULA | Fatigue | Discomfort | SPCS-W | SPCS-S |
| Young | 3.60 | 1.00 | 1.60 | 1.71 | 1.50 | 5.00 | 1.75 | 2.00 | 1.70 | 2.16 |
| Mid-Aged | 4.50 | 1.00 | 1.00 | 1.73 | 1.09 | 5.50 | 1.00 | 1.50 | 1.58 | 1.79 |
| Elder | 3.00 | 1.00 | 1.50 | 1.38 | 1.90 | 3.33 | 1.33 | 1.67 | 1.56 | 1.77 |
| Novice | 3.75 | 1.00 | 1.50 | 1.72 | 1.58 | 5.00 | 1.75 | 2.00 | 1.70 | 2.16 |
| Semi-Exper | 3.50 | 1.00 | 1.50 | 1.85 | 1.07 | 4.00 | 1.33 | 1.67 | 1.39 | 1.48 |
| Experienced | 3.67 | 1.00 | 1.33 | 1.80 | 1.25 | 4.50 | 1.00 | 1.50 | 1.83 | 2.24 |
| Male | 3.75 | 1.00 | 1.50 | 1.74 | 1.16 | 5.00 | 1.25 | 1.75 | 1.48 | 1.58 |
| Female | 3.60 | 1.00 | 1.40 | 1.81 | 1.51 | 4.20 | 1.60 | 1.80 | 1.74 | 2.25 |
| Overall | 3.67 | 1.00 | 1.44 | 1.78 | 1.36 | 4.56 | 1.44 | 1.78 | 1.63 | 1.95 |

The SPCS results revealed that when participants used severe shoulder postures, they generally used less severe wrist postures. This pattern suggests a tradeoff occurring between these joints when performing the filling task. The young, novice and female participants experienced the highest increase in fatigue with the Digger, as shown by the observed 75%, 75%, and 60% higher fatigue levels respectively. On the other hand, the mid-aged and experienced subjects experienced no increase in fatigue with the Digger. All other KPIs were not significantly different for any specific user category. P-values are shown in Appendix 7.

### 8.2. Filling Task Posture Observations

It was noted that the participants who experienced the most fatigue and discomfort held the Digger using a different handle position or scooped more weight than they could handle. Participant 6 grabbed the Digger from second grip 15 and scooped small loads; participant 2 grabbed tool 1 from first grip 14 and scooped large loads; participants 3 and 8 scooped medium loads and grabbed tool 1 from second grip 15, but eventually moved their hands to medial portion 12; the rest of the users held the Digger by medial portion 12 and scooped medium sized loads. Those participants who held the Digger from first grip 14 experienced more discomfort and fatigue, and the one participant who sustained this position for the whole activity with the largest load experienced the highest fatigue and discomfort levels. This particular test subject most likely skewed the subjective ratings because of the substantially higher scores obtained. For this type of activity where a participant is lifting heavy material from above waist height, holding the Digger with one hand from first grip 14 is inappropriate because it causes users to experience more strain in their shoulders due to having to lift higher, and because the longer distance from the load creates a greater strain due to the longer moment arm (approx 20% more force is needed).

Participant 6 held the Digger with one hand on second grip 15 and one hand on first grip 14 to avoid raising her shoulder every time the unloading was required. The posture helped this participant maintain better shoulder positioning at the expense of a more severe wrist posture.

Another participant number 13 held the Digger from the medial portion 12, which enabled her to have a better wrist posture at the expense of a high shoulder and arm elevation. This high degree of elevation positions the shoulder in an inappropriate posture, and places a high degree of stress and strain on this joint.

Another participant twisted her wrist to unload the sand from the standard gardening shovel. This movement was done by several of the participants since the limited load that can be carried with this tool suggested to them that twisting to scoop sand out of the bag and pour it into the gardening container is a more efficient method.

### 8.4. Digging Task General Results

The overall sample averages for each KPI and the average scores within each user category for the digging activity are displayed in table 7. The individual participant data for this task is displayed in appendix 2. The testing data demonstrated that for this task the Digger required less severe postures and led to less fatigue than the standard tool. The Paired T-test results are shown in Appendix 8.

More specifically, the Digger had an 8% overall average improvement in its RULA score and an 8% improvement in its SPCS wrist rating as compared to the standard digging tool. However, the fatigue and discomfort ratings revealed score increases of 31% and 6% respectively. These scores were noticed primarily in the young, novice, and female participant categories, whose ratings were 75%, 50%, and 67% higher than those of the standard tool. The SPCS shoulder rating indicated 18% more severe postures than the regular shovel, due primarily to three of the elder participants having unusually higher ratings and the elder category as a whole having a 23% higher score. The test results for the young, elder, and semi-experienced user categories indicated relatively high SPCS shoulder rating increases of 19% and 18% respectively. The remaining categories all had insignificant differences.

TABLE 4
Digging Task KPI Averages by Category

| | Shovel | | | | | Digger | | | | |
|---|---|---|---|---|---|---|---|---|---|---|
| Category | RULA | Fatigue | Discomfort | SPCS-W | SPCS-S | RULA | Fatigue | Discomfort | SPCS-W | SPCS-S |
| Young | 6.00 | 1.33 | 1.33 | 1.92 | 1.24 | 5.67 | 2.33 | 2.00 | 1.62 | 1.48 |
| Mid-Aged | 6.00 | 1.00 | 1.25 | 1.57 | 1.68 | 5.13 | 1.00 | 1.50 | 1.38 | 1.56 |
| Elder | 5.67 | 1.67 | 2.33 | 1.48 | 1.56 | 5.17 | 2.00 | 1.67 | 1.59 | 1.93 |
| Novice | 6.00 | 1.33 | 1.67 | 1.88 | 1.41 | 5.33 | 2.00 | 2.00 | 1.62 | 1.33 |
| Semi-Exper | 5.75 | 1.50 | 2.00 | 1.46 | 1.51 | 5.13 | 1.75 | 1.50 | 1.52 | 1.79 |
| Experienced | 6.00 | 1.00 | 1.00 | 1.66 | 1.62 | 5.50 | 1.33 | 1.67 | 1.41 | 1.76 |
| Male | 5.80 | 1.40 | 2.00 | 1.49 | 1.64 | 5.50 | 1.40 | 1.60 | 1.45 | 1.77 |
| Female | 6.00 | 1.20 | 1.20 | 1.80 | 1.40 | 5.20 | 2.00 | 1.80 | 1.58 | 1.52 |
| Overall | 5.90 | 1.30 | 1.60 | 1.65 | 1.52 | 5.40 | 1.70 | 1.70 | 1.52 | 1.78 |

### 8.5. Digging Task Posture Observations

The test results indicated that the mid-aged participants exhibited less severe postures and experienced less fatigue using the Digger compared to the standard shovel. One participant twisted his wrist in a counterclockwise movement when using the Digger. Since digging is a very repetitive task this type of movement ranks high on the RULA assessment due to the fact that it is risky for the joints of the wrist.

### 9. Conclusions

The ergonomic assessment of the Digger tool and a standard gardening shovel reveal that the ergonomic design of the Digger handle is a better tool for digging tasks. This conclusion is based on the fact that its handle's shape helps the user maintain a better posture of the wrist, helps avoid excessive twisting, and enables easier performance of the digging task. On the other hand, because of the size and design of the standard gardening tool, users of all ages and experience levels are led to position their wrists in unsuitable postures recurrently. These excessively repeated severe postures make the standard gardening shovel a less ergonomically suitable tool for digging.

It is worthy to note that the participants were not given any instruction as to prior use of the Digger. The advantages of tools using a handle of the present invention would be more readily seen in tests whereby participants use the tool and innovative handle in the proper manner.

In the case of performing the filling task, the standard gardening shovel was the more ergonomically suitable tool for the job. This is due to the tool's small shape, shorter handle and straight design, which make the tool more comfortable and easier to handle when carrying and unloading material into gardening containers. Digger design proved to be less ergonomically effective because its handle is twice as long as the standard shovel and the shape made it difficult to control and sustain the load when holding the tool in a neutral position. This implies that for the type of movements required when filling, a shorter handle that will keep the hand closer to the load is more suitable. In addition, the testing data revealed that when participants utilized the Digger their shoulder postures were in severe positions 44% more often than the regular shovel. This is attributable to the design of the tools and their sizes. The standard shovel allowed participants to maintain a neutral posture of their shoulders throughout the activity because of its handle's straight design, small length, and close proximity to the scoop. On the other hand, the longer and elevated handle of the Digger forced participants to raise and abduct their shoulders into severe postures in order to unload the sand into the gardening container.

As a whole, the results indicate that the Digger decreases the musculoskeletal strain for digging tasks or others performed at ground level, but at the expense of greater musculoskeletal strain for filling tasks and others performed at a raised level. There were no significant differences in discomfort levels, but this could be due to the short duration of the task. There were trends that did not reach significance suggesting that the Digger caused more fatigue than the standard tool. This result could be attributed to the Digger's larger scoop size, which allowed participants to lift heavier loads. These loads could easily fatigue a user that is not physically capable or accustomed to lifting heavy loads repetitively.

Overall, when the activity is being carried out in the ground or in a situation where the material to be dug up is below the user's waist, the extended handle of the Digger can do the job more efficiently. The Digger enables better pushing capability, keeps the user's trunk more upright because he/she doesn't have to bend over as much, and maintains the user's wrist in a neutral posture. The Digger had overall wrist posture and RULA rating improvements of 8%. However, when the material is at waist height or higher, the Digger is not as effective because users are required to raise their shoulders and abduct their arms in order to lift and maneuver the load. In this type of activity the Digger improved the wrist posture by 9%, but the regular shovel had a 24% better RULA score and a 44% better shoulder rating. For this type of activity a shorter tool such as the standard gardening shovel is recommended.

### 10. Recommendations

Based on the ergonomic testing the inventors ascertain:
1. The Digger was able to slightly improve the wrist posture in filling activities we recommend creating a smaller version of the Digger tool with a shorter handle, smaller handle elevation, smaller scoop, and less weight. Some participants also suggested eliminating the rear portion of the handle because it hampers the ability to place the tool in a container.
2. The handle as tested with a shovel tool is superior to conventional hand shovel for performing digging activities.
3. Ergonomics of its tools may be improved by:
   a. Reducing the size of the shovel tool by approximately 20% from the tested configuration to ensure that participants do not place so much strain on their shoulders, and so that less physically capable users do not experience high levels of fatigue.
   b. Reduce the distance from the shovel tool to the second angular portion by approximately 20%, to ameliorate the fatigue and shoulder ratings that would also improve the wrist ratings.

Filling Task Individual Test Results

| | Filling Task | | | | | | | | | |
|---|---|---|---|---|---|---|---|---|---|---|
| | Shovel | | | | | Digger | | | | |
| | | | | SPCS | SPCS | | | | SPCS | SPCS |
| Participant # | RULA | Fatigue | Discomfort | Wrist | Shoulder | RULA | Fatigue | Discomfort | Wrist | Shoulder |
| 1 | — | — | — | — | — | — | — | — | — | — |
| 2 | 3 | 1 | 2 | 1.21 | 2.48 | 4 | 3 | 4 | 1.17 | 2.80 |
| 3 | — | — | — | — | — | 4 | 2 | 3 | 1.28 | 1.38 |
| 4 | 3 | 1 | 2 | 1.81 | 1.15 | 3 | 1 | 1 | 1.40 | 1.27 |
| 5 | 3 | 1 | 2 | 1.67 | 1.16 | — | — | — | — | — |
| 6 | 4 | 1 | 1 | 1.63 | 1.27 | 4 | 1 | 1 | 2.04 | 1.32 |
| 7 | 4 | 1 | 1 | 1.89 | 1.00 | 5 | 1 | 1 | 1.50 | 1.78 |
| 8 | 5 | 1 | 1 | 1.57 | 1.19 | 6 | 1 | 2 | 1.65 | 1.81 |
| 9 | 3 | 1 | 1 | 2.17 | 1.40 | 3 | 1 | 1 | 2.00 | 2.67 |
| 10 | — | — | — | — | — | — | — | — | — | — |
| 11 | — | — | — | — | — | — | — | — | — | — |
| 12 | 4 | 1 | 1 | 1.90 | 1.17 | 7 | 1 | 1 | 1.61 | 1.87 |
| 13 | 4 | 1 | 2 | 2.17 | 1.40 | 5 | 2 | 2 | 2.00 | 2.67 |

APPENDIX 2
Digging Task Individual Test Results

| | Digging Task | | | | | | | | | |
|---|---|---|---|---|---|---|---|---|---|---|
| | Shovel | | | | | Digger | | | | |
| | | | | SPCS | SPCS | | | | SPCS | SPCS |
| Participant # | RULA | Fatigue | Discomfort | Wrist | Shoulder | RULA | Fatigue | Discomfort | Wrist | Shoulder |
| 1 | 6 | 1 | 1 | 1.73 | 1.58 | 5 | 1 | 2 | 1.43 | 1.67 |
| 2 | 7 | 2 | 2 | 2.58 | 1.16 | 6 | 4 | 4 | 1.83 | 0.97 |
| 3 | 5 | 3 | 4 | 1.22 | 1.62 | 5 | 2 | 3 | 1.56 | 1.84 |
| 4 | 6 | 1 | 2 | 1.45 | 1.35 | 6 | 1 | 1 | 1.65 | 2.11 |
| 5 | 6 | 1 | 1 | 1.64 | 1.42 | 6 | 2 | 1 | 1.27 | 1.71 |
| 6 | — | — | — | — | — | — | — | — | — | — |
| 7 | 6 | 1 | 1 | 1.39 | 1.36 | 5 | 1 | 1 | 1.31 | 1.39 |
| 8 | 6 | 1 | 1 | 1.60 | 1.87 | 6 | 1 | 2 | 1.52 | 1.89 |
| 9 | — | — | — | — | — | — | — | — | — | — |
| 10 | 6 | 1 | 2 | 1.54 | 1.93 | 5 | 1 | 1 | 1.26 | 1.28 |
| 11 | 6 | 1 | 1 | 1.77 | 1.73 | 5 | 3 | 1 | 1.56 | 1.83 |
| 12 | — | — | — | — | — | — | — | — | — | — |
| 13 | 5 | 1 | 1 | 1.52 | 1.15 | 5 | 1 | 1 | 1.76 | 1.75 |

APPENDIX 3
Filling Task SPCS Percentages
SPCS for Filling Task

| | Shovel | | | | | | Digger | | | | | |
|---|---|---|---|---|---|---|---|---|---|---|---|---|
| | Wrist | | | Shoulder | | | Wrist | | | Shoulder | | |
| # | Neutral | Mild | Severe | Neutral | Mild | Severe | Neutral | Mild | Severe | Neutral | Mild | Severe |
| 1 | — | — | — | — | — | — | — | — | — | — | — | — |
| 2 | 79.17% | 20.83% | 0.00% | 0.00% | 51.69% | 48.31% | 83.22% | 16.78% | 0.00% | 0.00% | 19.70% | 80.30% |
| 3 | — | — | — | — | — | — | 72.31% | 27.69% | 0.00% | 61.53% | 38.47% | 0.00% |
| 4 | 18.98% | 81.02% | 0.00% | 85.42% | 14.58% | 0.00% | 60.29% | 39.71% | 0.00% | 73.05% | 26.95% | 0.00% |
| 5 | 32.61% | 67.39% | 0.00% | 84.28% | 15.72% | 0.00% | — | — | — | — | — | — |
| 6 | 37.58% | 62.47% | 0.00% | 72.67% | 27.33% | 0.00% | 18.73% | 58.75% | 22.52% | 68.04% | 31.96% | 0.00% |
| 7 | 44.44% | 22.22% | 33.33% | 100.00% | 0.00% | 0.00% | 62.50% | 25.00% | 12.50% | 55.56% | 11.11% | 33.33% |
| 8 | 57.14% | 28.57% | 14.29% | 81.25% | 18.75% | 0.00% | 56.52% | 21.74% | 21.74% | 42.86% | 33.33% | 23.81% |
| 9 | 16.67% | 50.00% | 33.33% | 60.00% | 40.00% | 0.00% | 33.33% | 33.33% | 33.33% | 0.00% | 33.33% | 66.67% |
| 10 | — | — | — | — | — | — | — | — | — | — | — | — |
| 11 | — | — | — | — | — | — | — | — | — | — | — | — |
| 12 | 41.38% | 27.59% | 31.03% | 83.33% | 16.67% | 0.00% | 51.52% | 36.36% | 12.12% | 43.48% | 26.09% | 30.43% |
| 13 | 16.67% | 50.00% | 33.33% | 60.00% | 40.00% | 0.00% | 33.33% | 33.33% | 33.33% | 0.00% | 33.33% | 66.67% |
| Avg | 38.29% | 45.57% | 16.15% | 69.66% | 24.97% | 5.37% | 52.42% | 32.52% | 15.06% | 38.28% | 28.25% | 33.47% |

APPENDIX 4
Digging Task SPCS Percentages
SPCS for Digging Task

| | Shovel | | | | | | Digger | | | | | |
|---|---|---|---|---|---|---|---|---|---|---|---|---|
| | Wrist | | | Shoulder | | | Wrist | | | Shoulder | | |
| # | Neutral | Mild | Severe | Neutral | Mild | Severe | Neutral | Mild | Severe | Neutral | Mild | Severe |
| 1 | 46.72% | 33.13% | 20.15% | 61.04% | 20.35% | 18.61% | 57.43% | 42.57% | 0.00% | 56.96% | 18.99% | 24.06% |
| 2 | 0.00% | 41.93% | 58.07% | 84.28% | 15.72% | 0.00% | 28.30% | 60.04% | 11.66% | 65.41% | 15.72% | 0.00% |
| 3 | 77.58% | 22.42% | 0.00% | 38.34% | 61.66% | 0.00% | 55.76% | 32.83% | 11.41% | 32.27% | 51.23% | 16.50% |
| 4R | 65.37% | 24.00% | 10.63% | 65.34% | 34.66% | 0.00% | 34.82% | 65.18% | 0.00% | 10.75% | 67.82% | 21.43% |
| 4L | 100.00% | 0.00% | 0.00% | 100.00% | 0.00% | 0.00% | 88.49% | 11.51% | 0.00% | 70.93% | 29.07% | 0.00% |
| 5 | 50.00% | 35.71% | 14.29% | 58.33% | 41.67% | 0.00% | 72.73% | 27.27% | 0.00% | 42.86% | 42.86% | 14.29% |
| 6 | — | — | — | — | — | — | — | — | — | — | — | — |
| 7 | 61.11% | 38.89% | 0.00% | 63.64% | 36.36% | 0.00% | 69.23% | 30.77% | 0.00% | 61.11% | 38.89% | 0.00% |
| 8 | 55.00% | 30.00% | 15.00% | 26.67% | 60.00% | 13.33% | 57.14% | 33.33% | 9.52% | 31.58% | 47.37% | 21.05% |
| 9 | — | — | — | — | — | — | — | — | — | — | — | — |
| 10 | 53.85% | 38.46% | 7.69% | 21.43% | 64.29% | 14.29% | 73.91% | 26.09% | 0.00% | 75.38% | 21.54% | 3.08% |
| 11R | 40.91% | 40.91% | 18.18% | 27.27% | 72.73% | 0.00% | 63.64% | 27.27% | 9.09% | 61.11% | 27.78% | 11.11% |
| 11L | 100.00% | 0.00% | 0.00% | 100.00% | 0.00% | 0.00% | 50.00% | 44.44% | 5.56% | 25.00% | 66.67% | 8.33% |
| 12 | — | — | — | — | — | — | — | — | — | — | — | — |
| 13R | 100.00% | 0.00% | 0.00% | 100.00% | 0.00% | 0.00% | 41.18% | 41.18% | 17.65% | 25.00% | 75.00% | 0.00% |
| 13L | 52.17% | 43.48% | 4.35% | 84.62% | 15.38% | 0.00% | 92.31% | 7.69% | 0.00% | 64.29% | 28.57% | 7.14% |
| Avg | 67.84% | 25.15% | 7.01% | 64.73% | 32.51% | 2.76% | 64.34% | 31.47% | 4.18% | 46.80% | 44.56% | 8.64% |

APPENDIX 5
Filling Task Discomfort and Fatigue Surveys

| | Shovel | | | Digger | | | | |
|---|---|---|---|---|---|---|---|---|
| | | | Discomfort | | | Tool | # | Discomfort |
| # | Discomfort | Fatigue | Details | Discomfort | Fatigue | Positioning | Hands | Details |
| 1 | — | — | — | — | — | — | — | — |
| 2 | 2 | 1 | Hurt | 4 | 3 | Grabbed | 1 | Hurt shoulder and |
| | | | hand | | | from rear | | hand, and |
| | | | | | | Almost | | required a lot of |
| | | | | | | entire | | force to lift |
| | | | | | | activity | | load |
| 3 | — | — | — | 3 | 2 | Form rear | 1 | Hurt hand when |
| | | | | | | but | | holding from |
| | | | | | | eventually | | sign, and hurt |
| | | | | | | moved to | | wrist when |
| | | | | | | middle | | holding from rear |
| | | | | | | | | handle |
| 4 | 2 | 1 | Hurt | 1 | 1 | From middle | 1 | None |
| | | | wrist a | | | | | |
| | | | little | | | | | |
| | | | bit, | | | | | |
| | | | but | | | | | |
| | | | overall | | | | | |
| | | | did not | | | | | |
| | | | experience | | | | | |
| | | | any | | | | | |
| | | | other | | | | | |
| | | | discomfort | | | | | |
| 5 | 1 | 2 | Handle | — | — | — | — | — |
| | | | too | | | | | |
| | | | small | | | | | |
| 6 | 1 | 1 | None | 1 | 1 | Grabbed | 1 | None |
| | | | | | | from front | | |
| 7 | 1 | 1 | None | 1 | 1 | Grabbed | 1 | None |
| | | | | | | from middle | | |
| 8 | 1 | 1 | None | 2 | 1 | First from | 1 | Too heavy and |
| | | | | | | rear then | | hurt wrist when |
| | | | | | | moved to | | he held from rear |
| | | | | | | middle | | so moved hand |
| 9 | 1 | 1 | None | 1 | 1 | Grabbed | 1 | None |
| | | | | | | from middle | | |
| 10 | — | — | — | — | — | — | — | — |
| 11 | — | — | — | — | — | — | — | — |
| 12 | 1 | 1 | None | 1 | 1 | Grabbed | 1 | None |
| | | | | | | from middle | | |
| 13 | 2 | 1 | Bothered | 2 | 2 | Grabbed | 1 | Hurt her shoulder |
| | | | wrist | | | from middle | 1 | because had to |
| | | | a little | | | | | lift it too high |
| | | | bit | | | | | |

APPENDIX 6
Digging Task Discomfort and Fatigue Surveys

| | Shovel | | | Digger | | | | |
|---|---|---|---|---|---|---|---|---|
| | | | Discomfort | | | Tool | # | Discomfort |
| # | Discomfort | Fatigue | Details | Discomfort | Fatigue | Positioning | Hands | Details |
| 1 | 1 | 1 | None | 2 | 1 | One hand in | 2 | Wrist hurt |
| | | | | | | rear and | | |
| | | | | | | other in | | |
| | | | | | | front | | |
| 2 | 2 | 2 | Tired in | 4 | 4 | First from | 1 | Hurt palm, |
| | | | legs hut no | | | rear then | | fingers and |
| | | | pain in | | | moved to | | arm, but not |
| | | | hand, | | | middle | | wrist. |
| | | | wrist, or | | | | | Required too |
| | | | arm | | | | | much force |
| 3 | 4 | 3 | A lot of | 3 | 2 | Pushed from | 2 | Uncomfortable |
| | | | pressure in | | | rear, and | | for wrist, |
| | | | hand, and | | | lifted from | | and felt |
| | | | too much | | | middle | | pressure in |
| | | | ducking | | | | | hands |
| 4 | 2 | 1 | Hurt wrist | 1 | 1 | Started with | 1 & 2 | None |
| | | | a little | | | one hand in | | |
| | | | bit, but | | | rear and one | | |
| | | | overall did | | | in middle, | | |
| | | | not | | | and moved to | | |
| | | | experience | | | one in | | |
| | | | any other | | | middle | | |
| | | | discomfort | | | | | |
| 5 | 1 | 1 | None | 1 | 2 | Pushed from | 1 | None |
| | | | | | | rear, and | | |
| | | | | | | lifted from | | |
| | | | | | | middle | | |
| 6 | — | — | — | — | — | — | — | — |
| 7 | 1 | 1 | None | 1 | 1 | Grabbed from | 1 | None |
| | | | | | | middle | | |
| 8 | 1 | 1 | None | 2 | 1 | Grabbed from | 1 | Uncomfortable |
| | | | | | | middle | | grip |
| 9 | — | — | — | — | — | — | — | — |
| 10 | 2 | 1 | Uncomfortable | 1 | 1 | Grabbed from | 1 | None |
| | | | for | | | | | |
| | | | wrist | | | | | |
| 11 | 1 | 1 | None | 1 | 3 | One hand in | 2 | Too heavy |
| | | | | | | rear and | | and tiresome |
| | | | | | | other in | | |
| | | | | | | front | | |
| 12 | — | — | — | — | — | — | — | — |
| 13 | 1 | 1 | None | 1 | 1 | One hand in | 2 | None |
| | | | | | | rear and | | |
| | | | | | | other in | | |
| | | | | | | front | | |

APPENDIX 7
Filling Task Paired-T Tests

| | | | |
|---|---|---|---|
| N | Mean | StDev | SE Mean |

Paired T-Test and CI: Fill-Rula-Shovel, Fill-Rula-GDigger
Paired T for Fill-Rula-S − Fill-Rula-G

| | | | | |
|---|---|---|---|---|
| Fill-Rula-S | 9 | 3.667 | 0.707 | 0.236 |
| Fill-Rula-G | 9 | 4.556 | 1.333 | 0.444 |
| Difference | 9 | −0.889 | 0.928 | 0.309 |

95% CI for mean difference: (−1.602, −0.176)
T-Test of mean difference = 0 (vs not = 0): T-Value = −2.87
P-Value = 0.021

Paired T-Test and CI: Fill-Discomfort-Shovel, Fill-Discomfort-GDigger
Paired T for Fill-Disc-S − Fill-Disc-G

| | | | | |
|---|---|---|---|---|
| Fill-Disc-S | 9 | 1.444 | 0.527 | 0.176 |
| Fill-Disc-G | 9 | 1.778 | 1.093 | 0.364 |
| Difference | 9 | −0.333 | 0.866 | 0.289 |

95% CI for mean difference: (−0.999, 0.332)
T-Test of mean difference = 0 (vs not = 0): T-Value = −1.15
P-Value = 0.282

Paired T-Test and CI: Fill-Fatigue-Shovel, Fill-Fatigue-GDigger
Paired T for Fill-Fat-S − Fill-Fat-G

| | | | | |
|---|---|---|---|---|
| Fill-Fat-S | 9 | 1.000 | 0.000 | 0.000 |
| Fill-Fat-G | 9 | 1.444 | 0.726 | 0.242 |
| Difference | 9 | −0.444 | 0.726 | 0.242 |

95% CI for mean difference: (−1.003, 0.114)
T-Test of mean difference = 0 (vs not = 0): T-Value = −1.84
P-Value = 0.104

Paired T-Test and CI: Fill-SPCS-Wrist-Shovel,
Fill-SPCS-Wrist-GDigger
Paired T for Fill-SPCS-W-Sh − Fill-SPCS-W-G

| | | | | |
|---|---|---|---|---|
| Fill-SPCS-W- | 9 | 1.779 | 0.303 | 0.101 |
| Fill-SPCS-W- | 9 | 1.626 | 0.326 | 0.109 |
| Difference | 9 | 0.1522 | 0.2790 | 0.0930 |

95% CI for mean difference: (−0.0622, 0.3667)
T-Test of mean difference = 0 (vs not = 0): T-Value = 1.64
P-Value = 0.140

Paired T-Test and CI: Fill-SPCS-Shoulder-Shovel,
Fill-SPCS-Shoulder-GDigger
Paired T for Fill-SPCS-S-Sh − Fill-SPCS-S-G

| | | | | |
|---|---|---|---|---|
| Fill-SPCS-S- | 9 | 1.357 | 0.441 | 0.147 |
| Fill-SPCS-S- | 9 | 1.952 | 0.611 | 0.204 |
| Difference | 9 | −0.595 | 0.459 | 0.153 |

95% CI for mean difference: (−0.948, −0.242)
T-Test of mean difference = 0 (vs not = 0): T-Value = −3.89
P-Value = 0.005

APPENDIX 8
Digging Task Paired-T Tests

| | | | |
|---|---|---|---|
| N | Mean | StDev | SE Mean |

Paired T-Test and CI: Dig-Rula-Shovel, Dig-Rula-GDigger
Paired T for Dig-Rula-S − Dig-Rula-G

| | | | | |
|---|---|---|---|---|
| Dig-Rula-S | 10 | 5.900 | 0.568 | 0.180 |
| Dig-Rula-G | 10 | 5.400 | 0.516 | 0.163 |
| Difference | 10 | 0.500 | 0.527 | 0.167 |

95% CI for mean difference: (0.123, 0.877)
T-Test of mean difference = 0 (vs not = 0): T-Value = 3.00
P-Value = 0.015

Paired T-Test and CI: Dig-Discomfort-Shovel, Dig-Discomfort-GDigger
Paired T for Dig-Disc-S − Dig-Disc-G

| | | | | |
|---|---|---|---|---|
| Dig-Disc-S | 10 | 1.600 | 0.966 | 0.306 |
| Dig-Disc-G | 10 | 1.700 | 1.059 | 0.335 |
| Difference | 10 | −0.100 | 0.994 | 0.314 |

95% CI for mean difference: (−0.811, 0.611)
T-Test of mean difference = 0 (vs not = 0): T-Value = −0.32
P-Value = 0.758

Paired T-Test and CI: Dig-Fatigue-Shovel, Dig-Fatigue-GDigger
Paired T for Dig-Fat-S − Dig-Fat-G

| | | | | |
|---|---|---|---|---|
| Dig-Fat-S | 10 | 1.300 | 0.675 | 0.213 |
| Dig-Fat-G | 10 | 1.700 | 1.059 | 0.335 |
| Difference | 10 | −0.400 | 0.966 | 0.306 |

95% CI for mean difference: (−1.091, 0.291)
T-Test of mean difference = 0 (vs not = 0): T-Value = −1.31
P-Value = 0.223

Paired T-Test and CI: Dig-SPCS-Wrist-Shovel, Dig-SPCS-Wrist-Digger
Paired T for Dig-SPCS-W-Sh − Dig-SPCS-W-G

| | | | | |
|---|---|---|---|---|
| Dig-SPCS-W-S | 10 | 1.646 | 0.366 | 0.116 |
| Dig-SPCS-W-G | 10 | 1.516 | 0.200 | 0.063 |
| Difference | 10 | 0.130 | 0.328 | 0.104 |

95% CI for mean difference: (−0.104, 0.364)
T-Test of mean differaice = 0 (vs not = 0): T-Value = 1.26
P-Value = 0.241

Paired T-Test and CI: Dig-SPCS-S-Sh, Dig-SPCS-S-G
Paired T for Dig-SPCS-S-Sh − Dig-SPCS-S-G

| | | | | |
|---|---|---|---|---|
| Dig-SPCS-S-S | 10 | 1.515 | 0.274 | 0.087 |
| Dig-SPCS-S-G | 10 | 1.645 | 0.337 | 0.107 |
| Difference | 10 | −0.129 | 0.393 | 0.124 |

95% CI for mean difference: (−0.410, 0.152)
T-Test of mean difference = 0 (vs not = 0): T-Value = −1.04
P-Value = 0.325

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A tool handle for use with a tool head comprising:
(a) a proximal grip;
(b) a medial portion, connected to said proximal grip at a first angular vertex;
(c) a distal grip connected to said medial portion at a second angular vertex;
(d) a shaft connected at a first end to said distal grip at a third angular vertex and at a second end to a tool head;
wherein each of said angular vertices are along a contiguous handle with three angular inflections.

2. The tool handle of claim 1 wherein said inflections are each above a longitudinal axis.

3. The tool handle of claim 1 wherein said inflections lie in a common vertical plane.

4. The tool handle of claim 1 wherein said proximal grip forms an angular vertex with the medial portion such that the angle x formed on the underside of said handle is obtuse.

5. The tool handle of claim 4 comprising a distal grip that forms an angular vertex with the distal end of said medial portion such that the angle y formed on the underside of said handle is obtuse.

6. The tool handle of claim 5 comprising a distal grip that forms an angular vertex with a shaft such that the angle z is formed on the upper side of said handle is obtuse.

7. The tool handle of claim 6 wherein angle x, angle y, and angle z are congruent.

8. The tool handle of claim 6 wherein each of angles x, y and z have a measure between 110°-170°.

9. The tool handle of claim 1 wherein said handle further comprises central channel.

10. The tool handle of claim 1 wherein said medial portion further comprises a protrusion elevated from the upper surface of said medial portion.

11. The tool handle of claim 10 wherein said protrusion includes an interior protrusion cavity.

12. The tool handle of claim 10 wherein said protrusion has indicia incorporated into the upper surface.

13. The tool handle of claim 1 comprising a tool head.

14. The tool handle of claim 13 formed of a single contiguous piece.

15. The tool handle of claim 13 wherein said tool head is a rake, shovel, or hoe.

16. The tool handle of claim 13 wherein said tool head is formed as a single contiguous unit with the handle.

17. The tool handle of claim 13 comprising a connect/disconnect for the attachment and detachment of a tool head.

18. A tool comprising a handle and a tool head, said handle including:
(a) a proximal grip;
(b) a medial portion, connected to said proximal grip at a first angular vertex;
(c) a distal grip connected to said medial portion at a second angular vertex;
(d) a shaft connected at a first end to said distal grip at a third angular vertex and at a second end to a tool head;
wherein each angular vertex is congruent and obtuse.

19. The tool of claim 18 wherein each angular vertex lie in a common vertical plane.

20. A method of using the tool of claim 20 comprising the steps of:
(a) grasping said proximal grip with one hand;
(b) grasping said distal grip with a second hand;
(c) positioning said distal grip such that said tool head engages a desired functional position;
(d) moving said proximal grip downward;
said downward motion creating an ergonomically favorable motion for using said tool.
